(19) United States
(12) Patent Application Publication
(10) Pub. No.: US 2025/0084318 A1
(43) Pub. Date: Mar. 13, 2025

(54) DIRECT HEATING ELECTRIC FURNACE

(71) Applicants: Mark Philip Loring, Kerrville, TX (US); Keith McCarthy, Houston, TX (US); James Graham Williams, Montgomery, TX (US)

(72) Inventors: Mark Philip Loring, Kerrville, TX (US); Keith McCarthy, Houston, TX (US); James Graham Williams, Montgomery, TX (US)

(73) Assignee: KELLOGG BROWN & ROOT LLC, Houston, TX (US)

(21) Appl. No.: 18/825,931

(22) Filed: Sep. 5, 2024

Related U.S. Application Data
(60) Provisional application No. 63/581,599, filed on Sep. 8, 2023.

(51) Int. Cl. C10G 9/36; B01J 19/24

(52) U.S. Cl. CPC C10G 9/36; B01J 19/24; B01J 2219/00135; C10G 2300/1037; C10G 2300/807

(57) ABSTRACT

A steam cracking unit including one or more electric resistance heating tubes electrically connected to a current source to generate heat via electrical resistance heating. Each resistance heating tube may include two or more tube sections. Each tube section may be independently supplied with a current. A controller may be configured to adjust the application of the current to one or more tube sections to control the electrical resistance heating of the one or more resistance heating tubes. In examples, the one or more electric heating tubes may be used as preheating tubes, cracking tubes, or both.

### CROSS REFERENCE TO RELATED APPLICATION

This application claims priority to U.S. Provisional patent application having Ser. No. 63/581,599 filed on Sep. 8, 2023 which is incorporated by reference herein.

### FIELD OF THE INVENTION

The present disclosure relates to a method and process for direct heating in an electric furnace. In examples, the direct heating is employed for an ethylene furnace.

### DISCUSSION OF THE RELATED ART

Olefin cracking furnaces enable the production of essential raw materials for countless everyday products. They are typically large and complex pieces of equipment, and their design and operation require careful engineering to ensure efficient and safe production.

An olefin cracking furnace, also known as a steam cracker or ethylene cracker, is used to produce valuable petrochemicals such as ethylene and propylene from hydrocarbon feedstocks, often derived from crude oil or natural gas. Ethylene and propylene are key building blocks for a wide range of products, including plastics, synthetic fibers, detergents, and more.

The process that occurs within an olefin cracking furnace is generally referred to as steam cracking or ethylene cracking. This process involves breaking down larger hydrocarbon molecules into smaller ones by subjecting them to high temperatures and thermal cracking in the presence of steam. The process is typically carried out at temperatures ranging from 700° C. to 900° C. degrees Celsius and at atmospheric or slightly elevated pressure.

A typical process involves preheating a hydrocarbon feed, introducing the preheated feed into a reactor, undergoing a thermal cracking reaction, and quenching and optionally separating the effluent gas. The hydrocarbon feedstock often includes a mixture of light hydrocarbons such as naphtha or natural gas liquids. When the preheated hydrocarbon feed is introduced into the cracking furnace it generally comes into contact with a superheated environment that includes a mixture of steam or water vapor to help control the reaction and prevent the formation of undesirable byproducts. The high temperatures within the furnace cause the larger hydrocarbon molecules to break apart through a process of thermal cracking also referred to as pyrolysis. This results in the formation of smaller molecules, including ethylene and propylene, which are highly valuable in the petrochemical industry. After the cracking process, the mixture can be rapidly cooled down using quenching techniques to halt further reactions. The resulting mixture contains a variety of hydrocarbons, including the desired olefins (ethylene and propylene) as well as other byproducts. These mixtures may be sent to separation units where different components are separated based on their boiling points and properties and thus allow for the recovery of the produced olefins.

Olefin cracking furnaces typically include one or more radiant tubes through which the feed gas flows together with steam to undergo thermal cracking and produce olefins. Heating must be provided to generate the superheated environment to promote the thermal cracking process. A typical heating method is provided via one or more burners configured to burn fuel. The typical fuel used may include hydrocarbons such as methane. As such, the burning of the fuel to produce the desired heat can result in the formation of undesirable byproducts such as carbon dioxide. Carbon emission however is detrimental to the environment and often requires added processing to capture and/or recycle into other products.

There is a need, therefore, for providing improved processes and systems that can reduce carbon emission without greatly compromising production efficiency.

### SUMMARY OF THE INVENTION

Disclosed herein are examples of method and process for direct heating in an electric furnace can substantially obviates one or more of the problems due to limitations and disadvantages of the related art.

In examples, it may be possible to provide a process and/or system that can reduce carbon emission.

Additional features and advantages will be set forth in the description which follows, and in part will be apparent from the description, or may be learned by practice of the invention.

In examples, provided is a steam cracking unit that may include a resistance heating tube; and an electrical current supply connected to the resistance heating tube configured to apply a current to the resistance heating tube to induce electrical resistance heating.

In examples, the resistance heating tube may include a preheating tube.

In examples, the steam cracking unit may include a preheating section, and the preheating tube may be located at least in part in the preheating section.

In examples, the preheating tube may be configured to preheat a hydrocarbon feed, a steam feed, a mixed feed stream of hydrocarbon feed and steam feed, or any combination thereof.

In examples, the preheating tube may be arranged such that a feed is directed to flow through the preheating tube prior to reaching a pyrolysis section.

In examples, the resistance heating tube may include a cracking tube.

In examples, the steam cracking unit may include a pyrolysis section, and the cracking tube may be located at least in part in the pyrolysis section.

In examples, the steam cracking unit may include a rectifier to provide the electrical current supply.

In examples, the steam cracking unit may include a controller to adjust the electrical current supply to the resistance heating tube.

In examples, the resistance heating tube may include a curved or curvilinear shape. In examples, the resistance heating tube may include a U-shape.

In examples, the resistance heating tube may include two or more tube sections.

In examples, a first tube section may be connected to a second tube section by a pipe fitting configured to electrical-insulate the first tube section from the second tube section.

In examples, at least a first tube section of the two or more tube sections may be connected to the electrical current supply.

In examples, at least a second tube section of the two or more tube sections may be connected to a second electrical current supply.

In examples, the electrical current supply connected to the first tube section may be independent of the second electrical current supply connected to the second tube section.

In examples, the pipe fitting may include a first portion and a second portion configured to mate.

In examples, the steam cracking unit may include additional one or more resistance heating tubes.

In examples, the resistance heating tube and the additional one or more resistance heating tubes may be configured such that current flowing through adjacent tubes travels in opposite directions.

In examples, provided is a steam cracking process that may include feeding a hydrocarbon feed to one or more resistance heating tubes of a steam cracking furnace; applying a current to the one or more resistance heating tubes to induce electrical resistance heating while the hydrocarbon feed flows through the one or more resistance heating tubes; and preheating the hydrocarbon feed, cracking the hydrocarbon feed, or both while flowing through the one or more resistance heating tubes.

In examples, the steam cracking process may include feeding steam to the one or more resistance heating tubes to mix with the hydrocarbon feed.

In examples, the steam cracking process may include controlling the current applied to the one or more resistance heating tubes to adjust the electrical resistance heating.

In examples, applying a current to the one or more resistance heating tubes may include applying a current to a first tube section of one resistance heating tube of the one or more resistance heating tubes independently of a second tube section of the one resistance heating tube.

In examples, the electrical resistance heating may be the only heat generated in the steam cracking furnace.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a diagram illustration of an example steam cracking furnace with one or more electrical resistance heating tubes.

FIGS. 2A-2C are diagram illustrations of examples of tube sections and pipe fittings for connecting tube sections.

FIG. 3 illustrates an example circuit diagram for feeding electric current to one or more resistance heating tubes and/or tube sections.

FIG. 4 illustrates an example of resistance heating tubes as coils used as preheating tubes.

FIGS. 5A and 5B are illustrative diagrams of an example implementation of one or more resistance heating tubes as cracking tubes in a pyrolysis section of a steam cracking furnace.

FIG. 6 is a diagrammatic illustration of examples of types of curvilinear shapes that a resistance heating tube can have.

### DETAILED DESCRIPTION OF THE ILLUSTRATED EMBODIMENTS

In examples, described is a process and system that may obviate one or more problems in the prior art. In examples, the process and system as described herein may provide for direct heating to preheat a feed and/or to provide heating for the cracking reaction. In examples, one or more electrical resistance heating tubes (referred to herein as “resistance heating tubes”) may be employed to heat a fluid flowing therethrough for preheating, cracking, or both. In examples, one or more resistance heating tubes may include one or more preheating tubes that may be used in a cracking furnace and/or as part of a steam cracking unit. In examples, one or more resistance heating tubes may include one or more cracking tubes that may be used in a cracking furnace and/or as part of a steam cracking unit. In examples, the steam cracking unit may be employed in the formation of olefins. In examples, the one or more preheating tubes may be employed to preheating one or more feeds in a steam cracking unit for olefin production. In examples, one or more cracking tubes may be employed to carry out a cracking reaction of one or more hydrocarbons in a steam cracking unit for olefin production. In examples, other reactions may be performed in the cracking tubes. In examples, the process and system may be configured to induce heating to the gas flowing through a preheating tube and/or a cracking tube by electrical resistance heating by running a current through the tube walls of the preheating tubes and/or the cracking tubes.

In examples, a preheating tube and/or a cracking tube may independently be provided in two or more sections. In examples, each section may be electrically isolated from one or more other sections. In examples, each section may be thermally isolated from one or more other sections. In examples, the current flowing through each section of a preheating tube or of a cracking tube may be independently controlled.

In examples, the resistance heating tubes such as the preheating tubes and/or the cracking tubes may each independently include one or more materials that can conduct electricity. In examples, the thickness of the walls of the one or more preheating tubes and/or cracking tubes may each be independently configured to create a level of resistance that can induce heating of the preheating tube or cracking tube. In examples, the materials of the walls of the one or more preheating tubes and/or cracking tubes may each be independently selected to create a level of resistance that can induce heating of the preheating tube or cracking tube. In examples, the length of the one or more preheating tubes and/or cracking tubes may each be independently configured to create a level of resistance that can induce heating of the preheating tube or cracking tube. Any combination of wall thickness, material composition, and/or length of a resistance heating tube may be selected to create a level of resistance that can induce a desired heating of the resistance heating tube.

In examples, one or more controlled electrical rectifiers may be used to supply current to the one or more resistance heating tubes. In examples, one or more controlled rectifiers may be used to supply current to the one or more preheating tubes. In examples, one or more controlled rectifiers may be used to supply current to the one or more cracking tubes. In examples, the current provided to either a preheating tube or a cracking tube may be a variable current. In examples, the current may be direct current (DC) or alternating current (AC). In examples, the current may be a direct current.

In examples, one or more resistance heating tubes may be arranged to cancel-out magnetic fields to reduce magnetic field propagation away from the cracking furnace. For example, one or more cracking tubes may be arranged to cancel-out magnetic fields at the cracking tubes system. In examples, the one or more preheating tubes may be arranged to cancel-out magnetic fields at the preheating tubes system.

In examples, the one or more resistance heating tubes such as the cracking tubes may be configured to allow for thermal expansion. In examples, the system is configured such that the thermal expansion does not affect the fixed connection points used to introduce current and/or gas flow in the one or more cracking tubes. In examples, the one or more preheating tubes may be configured to allow for thermal expansion. In examples, the system is configured such that the thermal expansion does not affect the fixed connection points used to introduce current and/or gas flow in the one or more preheating tubes.

In examples, a steam cracking process for olefin production may include employing the use of a steam cracking unit that may include one or more resistance heating tubes as described herein. In examples, the resistance heating tubes may be preheating tubes, cracking tubes, or both. In examples, a hydrocarbon feed and steam may be fed to the steam cracking unit. In examples, the steam cracking unit may preheat the hydrocarbon feed and/or steam feed. In examples, the steam cracking unit may mix the preheated hydrocarbon feed with the steam to form a mixed feed stream. In examples, the mixed feed stream may optionally further be preheated. In examples, preheating of one or more streams may occur in a preheating section of the steam cracking furnace. In examples, fed streams may be made to flow through one or more preheating tubes located in the preheating section. In examples, the one or more preheating tubes may include one or more resistance heating tubes. In examples, the feed streams may be heated by direct heating generated by electrical resistance heating by applying a current to the one or more preheating tubes. In examples, the preheated hydrocarbon feed, steam, and/or mixed feed stream may be fed to one or more cracking tubes in the pyrolysis section of the steam cracking furnace. In examples, the one or more cracking tubes may include one or more resistance heating tubes. In examples, the hydrocarbons in the fluid flowing through the one or more cracking tubes is cracked while the preheated stream flows through the one or more cracking tubes. In examples, heat for the cracking reaction may be provided via direct heating by electrical resistance heating by applying a current to one or more cracking tubes. In examples, an effluent of the one or more cracking tubes may include olefin. In examples, the current supplied to the one or more preheating tubes and/or cracking tubes may be controlled by one or more controllers. In examples, one or more heating sources may be employed to supplement and/or replace the direct heating provided by the one or more preheating tubes and/or by the one or more cracking tubes.

In examples, implementation of the system and process as described may lead with a reduction and/or elimination of carbon emission.

Reference will now be made in detail to an embodiment of the present invention, example of which is illustrated in the accompanying drawings.

Unless defined otherwise, all technical and scientific terms used herein have the same meaning as is commonly understood by one of skill in the art to which the inventions belong. All patents, patent applications, published applications and publications, websites and other published materials referred to throughout the entire disclosure herein, unless noted otherwise, are incorporated by reference in their entirety. Where there is a plurality of definitions for terms herein, those in this section prevail. Where reference is made to a URL or other such identifier or address, it is understood that such identifiers can change and information on the internet can come and go, but equivalent information can be found by searching the internet. Reference thereto evidences the availability and public dissemination of such information.

As used herein, the singular forms “a”, “an” and “the” include plural referents unless the context clearly dictates otherwise.

The terms first, second, third, etc. as used herein can describe various elements, components, regions, layers and/or sections, these elements, components, regions, layers and/or sections should not be limited by these terms. These terms may be only used to distinguish one element, component, region, layer or section from another region, layer, or section. Terms such as “first”, “second”, and other numerical terms when used herein do not imply a sequence or order unless clearly indicated by the context. Thus, a first element, component, region, layer, or section discussed below could be termed a second element, component, region, layer, or section without departing from the teachings of the example embodiments.

As used herein, ranges and quantities can be expressed as “about” a particular value or range. “About” also includes the exact amount. Hence “about 5 percent” means about 5 percent in addition to 5 percent. The term “about” means within typical experimental error for the application or purpose intended.

As used herein, “and/or” includes any and all combinations of one or more of the associated listed items.

As used herein, a “combination” refers to any association between two items or among more than two items. The association can be spatial or refer to the use of the two or more items for a common purpose.

As used herein, “comprising” and “comprises” are to be interpreted to mean “including but not limited to” and “includes but not limited to”, respectively.

As used herein, “optional” or “optionally” means that the subsequently described event or circumstance does or does not occur, and that the description includes instances where the event or circumstance occurs and instances where it does not. For example, an optional component in a system means that the component may be present or may not be present in the system.

As used herein, “substantially” means “being largely but not wholly that which is specified.”

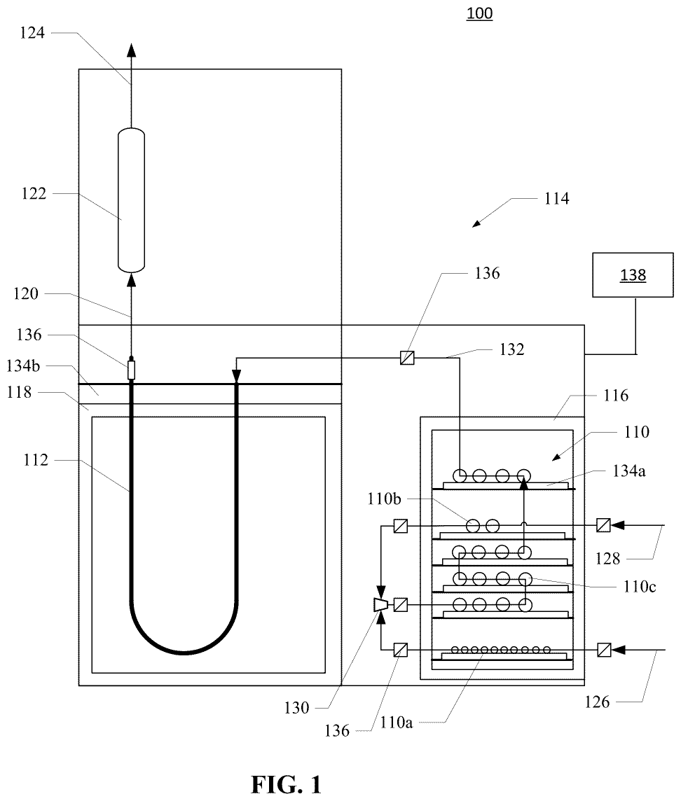

FIG. 1 illustrates an example of a system that may include a steam cracking unit 100 including a cracking furnace 114. In examples, cracking furnace 114 may include a preheating section 116 and a pyrolysis section 118. In examples, the preheating section 116 may be configured to preheat one or more feeds for the cracking reaction. In examples, the pyrolysis section 118 may be configured to provide sufficient heat to crack one or more hydrocarbons in the presence of steam contained in the one or more feeds that flow through the pyrolysis section 118. In examples, the cracking of hydrocarbons can lead to the production of one or more olefins.

In examples, the steam cracking unit 100 may include resistance heating tubes such as preheating tubes 110 or cracking tubes 112. In examples, the steam cracking unit 100 may include one or more preheating tubes 110 and one or more cracking tubes 112. In examples, the one or more preheating tubes 110 may be provided at least in part in the preheating section 116. In examples, the one or more cracking tubes 112 may be provided at least in part in pyrolysis section 118.

For purposes of this description, the term “resistance heating tube” is used to refer to the electrically conductive conduits or pipes that may apply direct heating to a fluid flowing therethrough. As described here, resistance heating tubes may be located in preheating section 116 of a steam cracking furnace 114, pyrolysis section 118 of a steam cracking furnace 114, or both. As used herein, the term “preheating tube(s)” is used to refer to the one or more resistance heating tubes in which preheating of a gas may occur as a feed gas flows through them. In examples, if additional heating means are used in the preheating section to supplement and/or replace the direct heating provided by resistance heating of the preheating tubes, the preheating tubes may function also as convection tubes. For purposes of this description, the term “cracking tube(s)” is used to refer to the one or more resistance heating tubes in which a cracking reaction may occur as a feed gas flows through them. In examples, if additional heating means are used in the pyrolysis section to supplement and/or replace the direct heating provided by resistance heating of the cracking tubes, the cracking tubes may function also as radiant tubes. In examples, the feed gas may be fed to one or more cracking tubes together with steam to undergo a cracking reaction and produce olefins. In examples, the preheating tubes and the cracking tubes may be independently configured to provide direct heating to a fluid flowing therethrough.

In examples, the preheating may be performed by directing one or more feeds to flow through one or more preheating tubes 110. In examples, one or more feeds may be preheated by flowing through one or more preheating tubes 110. In examples, the preheating may occur prior to directing one or more feeds to the pyrolysis section 118. In examples, the heat for preheating in the preheating tubes may be solely provided by the preheating tubes 110.

In examples, a hydrocarbon feed 126 may be fed to one or more preheating tubes 110a of a steam cracking furnace. In examples, hydrocarbon feed 126 may include one or more hydrocarbons. In examples, hydrocarbon feed 126 may be gas or liquid. In examples, the one or more preheating tubes 110a may be configured to preheat the hydrocarbon feed 126 as the hydrocarbon feed 126 flows therethrough.

In examples, steam 128 may be fed to one or more preheating tubes 110b of a steam cracking furnace 114. In examples, the one or more preheating tubes 110b may be configured to preheat and/or superheat the steam 128 as the steam 128 flows therethrough.

In examples, after an initial preheating by one or more preheating tubes 110a the hydrocarbon feed 126 may be combined with the preheated steam 128 from one or more preheating tubes 110b. In examples, preheated hydrocarbon feed 126 may be combined with preheated or superheated steam 128 at mixing manifold 130 to produce a mixed feed stream 132. In examples, the mixed feed stream 132 may be fed directly to the one or more cracking tubes 112 in the pyrolysis section 118 of the cracking furnace 114. In examples, as shown, the mixed feed stream 132 may be further preheated via one or more preheating tubes 110c prior being directed to the one or more cracking tubes 112 in the pyrolysis section 118 of the cracking furnace 114. In examples, the mixed feed stream 132 may further preheat as it flows through the one or more preheating tubes 110c.

In examples, the heat for the preheating of the hydrocarbon feed 126, steam 128, and/or mixed feed stream 132 in the preheating tubes may be provided at least in part by the preheating tubes 110. In examples, the heating by the one or more preheating tubes 110 may be achieved by electrical resistance heating while the hydrocarbon feed 126, steam 128, and/or mixed feed stream 132 flow through the respective one or more preheating tubes 110. In examples, electrical resistance heating may be carried out by supplying a current to one or more preheating tubes 110. In examples, electrical resistance heating may occur as current flows through the walls one or more preheating tubes 110. In examples, electrical resistance heating may be the only heat generation in the preheating section 116 of the cracking furnace 114 and/or of the steam cracking unit 100.

In examples, one or more additional heat sources may be used in the preheating section 116. Additional heat sources may include, but are not limited to, heat transfer from the pyrolysis section 118, one or more burners, heating elements provided about one or more preheating tubes 110 and/or about the furnace 114 and/or preheating section 116, one or more heat exchangers, and/or one or more effluent quenchers. In examples, additional heat sources in preheating section 116 may provide heat to replace resistance heating and/or to supplement resistance heating provided by the one or more preheating tubes 110. In examples, when an additional heating source is present in preheating section 116, the one or more preheating tubes 110 may function as or also as convection tubes.

In examples, one or more feeds may be directed to pyrolysis section 118 to flow through one or more cracking tubes 112. In examples, one or more feeds directed to pyrolysis section 118 may be preheated by the time they reach one or more cracking tubes 112. In examples, the one or more feeds directed to pyrolysis section 118 may have passed through preheating section 116 and/or flowed through one or more preheating tubes 110 prior to reaching the pyrolysis section 118 and/or one or more cracking tubes 112.

In examples, a cracking reaction may take place as fluid of the feeds travel through the one or more cracking tubes 112. In examples, the fluid of the one or more feeds may include one or more hydrocarbons from hydrocarbon feed 126, steam from steam feed 128, or a mixture thereof. In examples, a hydrocarbon feed 126 may be fed to one or more cracking tubes 112 of the steam cracking furnace 114. In examples, steam 128 may be fed to one or more cracking tubes 112 of steam cracking furnace 114 together with the hydrocarbon feed. In examples, a mixed feed stream 132 including the hydrocarbon feed 126 and steam 128 may be fed to the one or more cracking tubes 112 of the steam cracking furnace 114.

In examples, an effluent 120 of the one or more cracking tubes 112 from pyrolysis section 118 may include a gas mixture. In examples, effluent 120 may include one or more olefins, hydrogen, one or more hydrocarbons such as methane, or any combination thereof. In examples, effluent 120 may optionally be directed to one or more quenchers 122. In examples, after quenching, the quenched effluent 124 may be directed to additional processing. In examples, the one or more quenchers 122 may be configured to recover heat from the effluent 120 to preheat and/or supplement the preheating of a feed or steam in the preheating section. In examples, the supplemental preheating may be in addition to the resistance heating by the one or more preheating tubes 110. In examples, this may reduce the power consumption to preheat the hydrocarbon feed, steam feed, and/or mixed feed stream.

In examples, the heat for the cracking reaction occurring in the cracking tubes 112 may be solely provided by the cracking tubes 112. In examples, the one or more cracking tubes 112 may be heated while the mixed feed stream 132 flows through the one or more cracking tubes 112. In examples, one or more hydrocarbons from hydrocarbon feed 126 contained in the mixed feed stream 132 may undergo a cracking reaction as mixed feed stream 132 flows through the one or more cracking tubes 112. It is noted that although only one cracking tube is shown in FIG. 1, this is only a diagram. In examples, as also described in more detail later, a plurality of cracking tubes 112 may be present. In examples, the heat for the reaction occurring in the cracking tubes 112 may be provided at least in part by the cracking tubes 112. In examples, the heating of the one or more cracking tubes 112 may be achieved by electrical resistance heating while the mixed feed stream 132 flows through the one or more cracking tubes 112. In examples, electrical resistance heating may be carried out by supplying a current to one or more cracking tubes 112. In examples, electrical resistance heating may occur as current flows through one or more cracking tubes 112. In examples, electrical resistance heating may be the only heat generation in the steam cracking furnace 114 and/or pyrolysis section 118 of steam cracking furnace 114.

In examples, one or more additional heat sources may be used. Additional heat sources may include, but are not limited to, heat transfer from the preheating section 116, one or more burners, heating elements provided one or more cracking tubes 112 and/or about the steam cracking furnace 114 and/or pyrolysis section 118. In examples, additional heat sources in pyrolysis section 118 may provide heat to replace resistance heating and/or to supplement resistance heating provided by the one or more cracking tubes 112. In examples, when an additional heating source is present in pyrolysis section 118, the one or more cracking tubes 112 may function as or also as radiant tubes.

Although the present description discusses the use of electrical resistance heating for both preheating tubes 110 and for cracking tubes 112, it should not be understood to be so limited. In examples, the steam cracking unit 100 may employ electrical resistance heating only in the preheating section 116, only in the pyrolysis section 118, or in both the preheating section 116 and in the pyrolysis section 118. In examples, where electrical resistance heating in not used in one section, other heating means may be used. Other heating means may include burners, electric heating jackets, heat transfer, or any combination thereof.

In examples, heat may be transferred between preheating section 116 and pyrolysis section 118. In examples, heat from the pyrolysis section 118 may be recovered. In examples, heat recovered from the pyrolysis section 118 may be used to heat one or more different streams. In examples, heat from pyrolysis section 118 may be transferred to preheating section 116 to be used for preheating one or more feeds flowing through one or more preheating tubes 110 and/or other coil or tube that may extend through preheating section 116. In examples, heat recovered from the pyrolysis section 118 may be used in the preheating section 116 to pre-heat a feed to one or more cracking tubes 112, such as hydrocarbon feed 126, steam feed 128, and/or mixed feed stream 132, heat water to yield heated water, steam, or superheated steam. Any combination of one or more of the above heating may be implemented based on the amount of heat available for recovery by preheating section 116. In examples, steam cracking unit 100 may be configured such that heat generated in pyrolysis section 118 may be recovered in preheating section 116.

Also, in examples, other heating means may be used in combination with electrical resistance heating to supplement heating provided by electrical resistance heating in the preheating section 116 and/or the pyrolysis section 118.

In examples, the one or more preheating tubes and the one or more cracking tubes may independently include a material that is electrically conductive. In examples, the electrically conductive materials that may be used for preheating tube and/or cracking tubes may include nickel, chrome, steel, or any combination thereof. Other materials may also be used.

In examples, a resistance heating tube such as a preheating tube may include a preheating tube wall. Likewise in examples, a resistance heating tube such as a cracking tube may include a cracking tube wall. As used herein, the wall of a resistance heating tube such as a wall of a preheating tube or of a cracking tube refers to the structure that defines the duct through which a fluid is caused to flow. This means that an internal surface of the resistance heating tube wall, such as of a preheating tube wall or of a cracking tube wall, will be exposed to and/or come in contact with the fluid that is caused to flow through the resistance heating tube such as preheating tube or cracking tube.

In examples, the thickness of a resistance heating tube wall such as a preheating tube wall and of a cracking tube wall may vary. In examples, the thickness of a resistance heating tube wall such as a preheating tube and/or of a cracking tube wall may range from about 5 mm to about 15 mm. Thicknesses outside this range may also be used. It is noted that thinner walls may provide higher resistance and thus require less current, but a higher driving voltage. While thicker walls provide less resistance and thus may require more current to provide the desired heating.

In examples, the dimensions and/or metallurgy of a resistance heating tube may be the same or different from the dimensions and/or metallurgy of another resistance heating tube.

In examples, when two or more preheating tubes 110 are present, the dimensions and/or metallurgy of one preheating tube may be the same or different from that of another preheating tube. In examples, all preheating tubes present may have the same dimensions and/or metallurgy. In examples, at least one preheating tube may have the same dimensions and/or metallurgy as at least one other preheating tube.

Similarly, in examples, when two or more cracking tubes 112 are present, the dimensions and/or metallurgy of one cracking tube may be the same or different from that of another cracking tube. In examples, all cracking tubes present may have the same dimensions and/or metallurgy. In examples, at least one cracking tube may have the same dimensions and/or metallurgy as at least one other cracking tube.

In examples, the one or more resistance heating tubes may include one or more tube sections as described later interconnected by one or more insulating connection 136.

In examples, the direct heating in a resistance heating tube such as a preheating tube 110 and/or in a cracking tube 112 may be provided via electrical resistance heating. In examples, electrical resistance heating may be obtained driving an electric current through the tube wall, such as preheating tube wall or cracking tube wall, and using the resistance of the tube wall of the preheating tube itself or cracking tube itself to heat it and keep the contents flowing. In examples, by applying a current to a resistance heating tube such as the preheating tubes or cracking tubes, it may be possible to direct heat transfer from the heated tube wall, such as the preheating tube wall or the cracking tube wall, to the fluid passing through the resistance heating tube (preheating tube and/or cracking tube). This may reduce or eliminate the need for one or more heat transfer mediums. In examples, a current may be applied and/or supplied to the one or more cracking tubes to induce electrical resistance heating of the one or more cracking tubes while the hydrocarbon feed flows through the one or more cracking tubes.

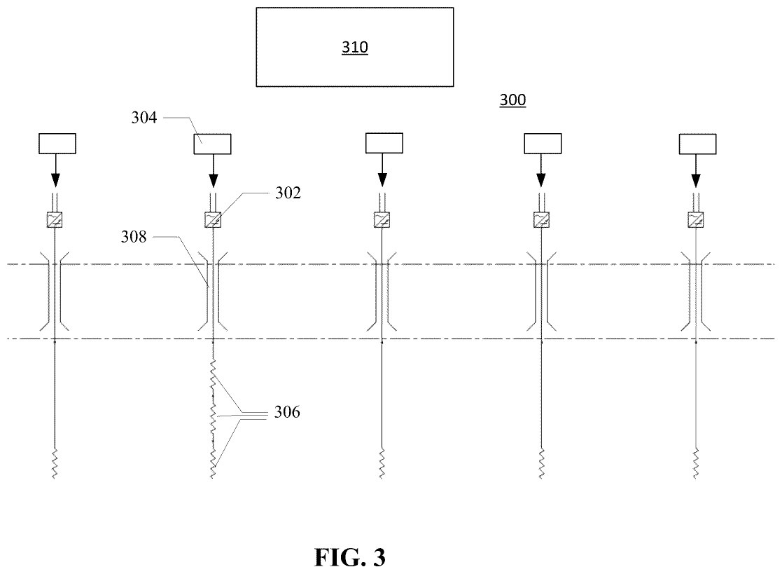

In examples, the current to the one or more resistance heating tubes, such as preheating tubes 110 and/or cracking tubes 112, may be provided by a current supply system 138 later described in more detailed with reference to FIG. 3. As discussed further later, in examples, the current to the one or more resistance heating tubes, such as preheating tubes 110 and/or cracking tubes 112, may be controlled to balance the cooling of the fluid passing through the one or more preheating tube and/or cracking tubes. In this manner, the system may manage the heat transfer to prevent burnout by taking advantage of the direct cooling of the resistance heating tubes such as preheating tubes and/or cracking tubes provided by the fluid passing therethrough.

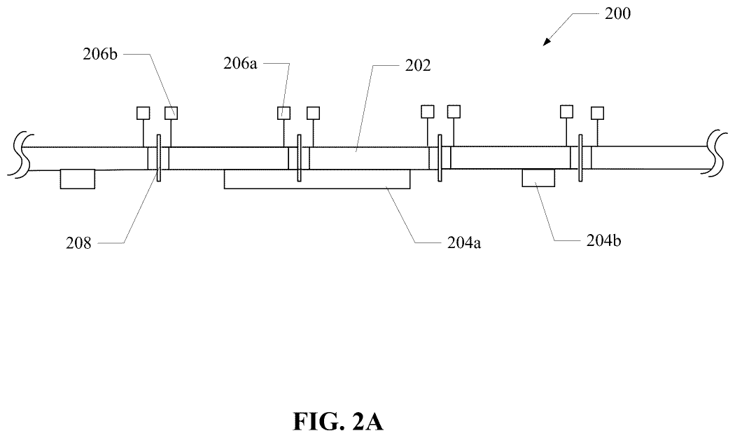

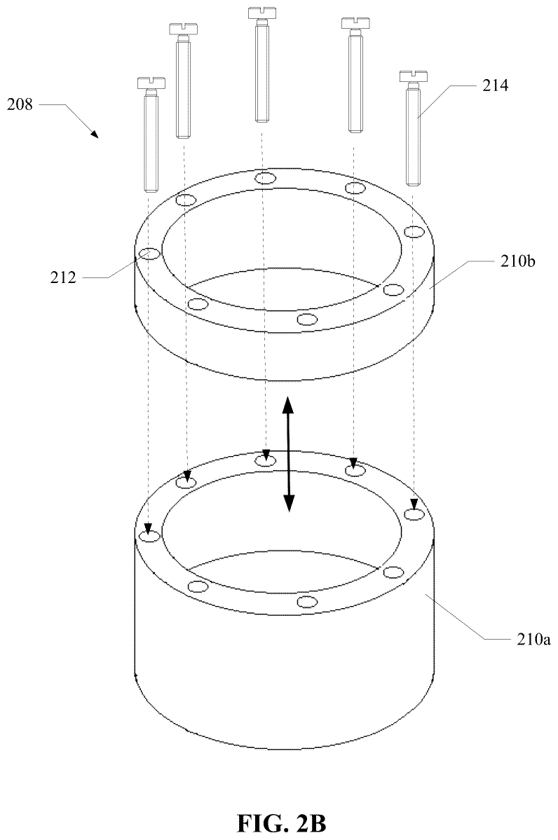

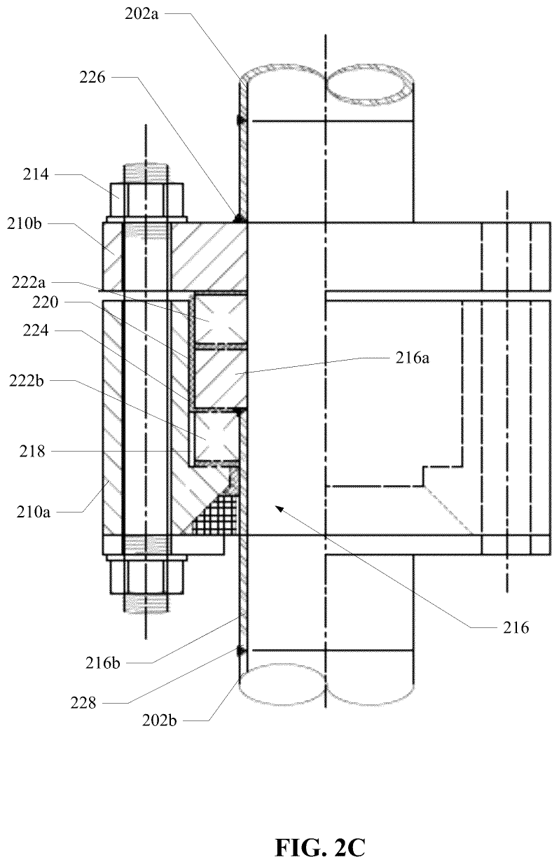

In examples, as illustrated in FIG. 2A, a resistance heating tube 200 such as a preheating tube 110 and/or a cracking tube 112 may include one or more tube sections 202. In examples, a preheating tube 110 and/or a cracking tube 112 may include one or more tube sections 202. In examples, two or more tube sections 202 may be connected to form one or more resistance heating tubes 200 such as one or more preheating tubes 110 or one or more cracking tubes 112. In examples, a tube section 202 may be independently supported via one or more supports 204 (i.e. 204a, 204b, ect . . . ). In examples, a tube section 202 may have its own support 204a. In examples, a common support 204b may support two or more tube sections 202. FIG. 1 also illustrates an example of a common support 134a as may be used to support two or more tube sections 202 of one or more preheating tubes 110. FIG. 1 also illustrates an example of a common support 134b as may be used to support two or more tube sections 202 of one or more cracking tubes 112. Although not shown in FIG. 1, one or more supports may also be provided in the pyrolysis section 118.

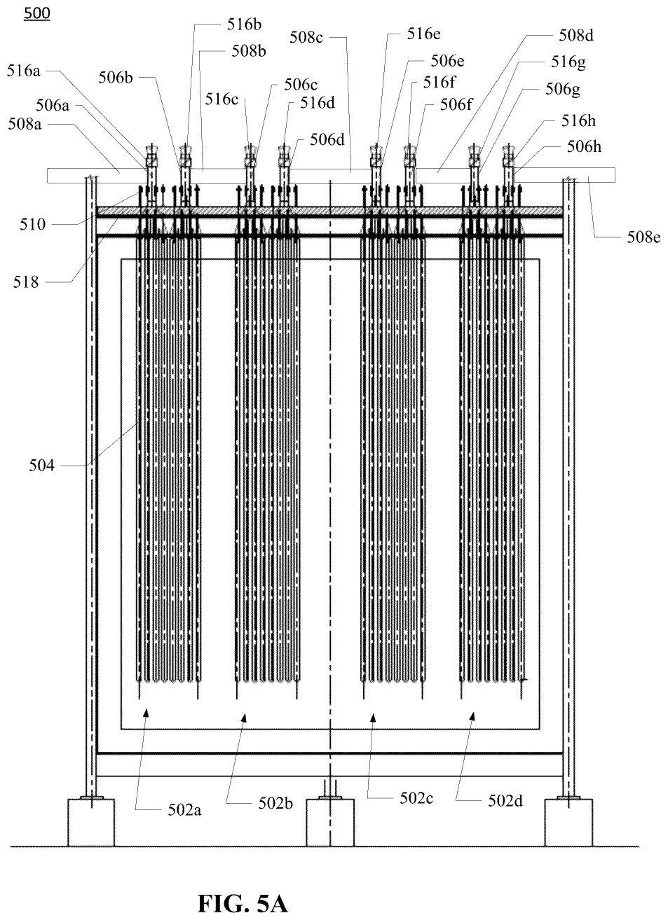

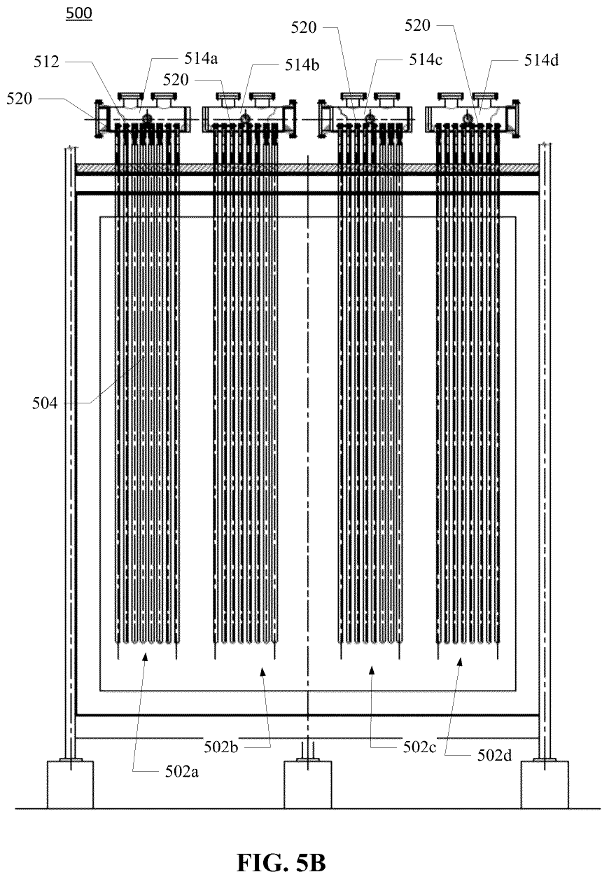

In examples, one or more resistance heating tubes such as the preheating tubes and/or the cracking tubes may be laid (not fixed) on their sides on one or more insulated supports as for example the preheating tubes 110 on support 134a illustrated in FIG. 1. In examples, the one or more resistance heating tubes may include one electrical terminal end for example as illustrated in FIG. 5A. In examples, the one or more resistance heating tubes may include only one electrical terminal end. In examples, the electrical terminal end may be fixed in place as also illustrated in FIG. 5A.

In examples, the one or more supports 134 (e.g. 134a, 134b) and/or 204 may include a high temperature material. In examples, one or more supports 134 and/or 204 may include a refractory material. In examples, the refractory material may include a refractory cement. In examples, the one more supports 204 may all include the same material. In examples, while supporting the one or more resistance heating tubes 200, the one or more supports 134 and/or 204 may allow one or more resistance heating tubes 200 to expand and contract. In examples, a resistance heating tube 200 may expand and contract as its temperature varies. For example, one or more resistance heating tubes may be configured to expand and/or grow longitudinally as they are heated. Also, for example, one or more resistance heating tubes may be configured to retract and/or shrink longitudinally as they cool. In examples, one or more resistance heating tubes may be configured to expand and retract as they may cycle through different temperatures. In examples, different supports 204 may include different materials based on their location. For example, supports 204 for one or more tube sections 202 that form a cracking tube 112 may include a material that is able to maintain structural and functional integrity at temperatures higher than supports 204 for one or more tube sections 202 that form a preheating tube 110. This may be because cracking tube 112 may likely operate at a temperature that is higher than the operating temperature of a preheating tube 110.

In examples, a tube section 202 may include one or more electrical connections 206 (e.g. 206a, 206b, etc. . . . ). In examples, an electrical connection 206 may be configured to apply a current to a tube section 202. In examples, one or more electrical connections 206 may be made to the one or more resistance heating tubes such as preheating tubes and/or cracking tubes. In examples, an electrical connection 206 may be configured to transfer an electric current to a resistance heating tube. For example, a first end of a tube section may be connected to the positive terminal 206a of a power supply and a second end of the tube section may be connected to the negative terminal 206b of the power supply. In examples, one or more tube sections 202 may be similarly connected. In examples, each tube section 202 may be similarly connected. In examples, an electrical connection 206 to a tube section 202 may be connected to a conductive bus bar. In examples, a bus bar may extend from an electrical rectifier to one or more impedance heat tubes and/or tube sections as, for example, described later with reference to FIG. 3.

In examples, one or more pipe fittings 208 may be used to connect a tube section 202 to one or more other tube sections 202 and/or other structures. In examples, a pipe fitting 208 may be used for one or more insulating connections 136 shown in FIG. 1, and/or insulating connection 516 discussed later with reference to FIG. 5. FIGS. 2B and 2C illustrate an example of a pipe fitting 208. The structure illustrated in FIGS. 2B and 2C is only an example as other suitable pipe fitting designs may also be used. In examples, a pipe fitting 208 may be configured to electrical-insulate the connected tube sections. In examples, a pipe fitting 208 may be configured to exhibit one or more desired properties. In examples, a pipe fitting 208 may exhibit adequate mechanical strength. In examples, a pipe fitting 208 may provide a gas-tight connection. In examples, a pipe fitting 208 may be configured to properly function (i.e. maintain structural and functional integrity) at temperatures approaching 1,100° C. In examples, a pipe fitting 208 may include two or more connecting portions 210 (i.e. 210a and 210b). In examples, pipe fitting 208 may include a first portion and a second portion configured to mate with each other. In examples, a pipe fitting 208 may include one or more bores 212. In examples, bores 212 may be configured to receive one or more fasteners 214 such as screws, bolts, pins, or other like structure for connecting a first portion 210a of the pipe fitting 208, to a second portion 210b of the pipe fitting 208. In examples, first portion 210a and second portion 210b of a pipe fitting 208 may include a material selected from a metal or metal alloy. In examples, first portion 210a and second portion 210b may include the same or different material as the tube sections pipe fitting 208 is connecting.

In examples, as shown in FIG. 2C the pipe fitting 208 may include a portion configured to encase a connecting structure 216. FIG. 2C illustrates a cross-section view of pipe fitting 208 connecting a first tube section to a second tube section. In examples, connecting structure 216 may include a material similar or same as used for the tube section to which it is configured to connect, and/or for first and/or second portion 210a and 210b of pipe fitting 208. In examples, a connecting structure 216 may include a flange portion 216a and a stub portion 216b. In examples, connecting structure 216 may be one integral structure. In examples, flange portion 216a may be welded to stub portion 216b. In examples, a portion of pipe fitting 208 may include a recess 218 at an internal portion thereof. In examples, the internal recess 218 may be configured to receive a first end of connecting structure 216, for example, flange portion 216a. In examples, internal recess 218 may be a circular recess that extends along the full internal circumference of a portion of pipe fitting 208. In examples, the internal recess 218 may be configured to provide an electrical creep distance (gap) 220 between an outer circumference of the first end of the connecting structure 216 received in recess 218 and outer wall of the portion of pipe fitting 208 that encages the connecting structure 216. In examples, the creep distance 220 may range from about 3 mm to about 5 mm.

In examples, one or more insulating rings 222 (i.e. 222a and 222b) may be provided in the internal recess 218 to electrically insulate the connecting structure 216 from the first and/or second portion of the pipe fitting 208. In examples, an insulating ring 222 may include an insulating material. In examples, any suitable insulating material may be used. In examples, an insulating ring 222 may include a ceramic. In examples, an insulating ring 222 may be configured to extend the full internal circumference of at least one portion of pipe fitting 208 and/or internal recess 218. In examples, as shown in FIG. 2C, a first insulating ring 222a may be provided above the first end of connecting structure 216, e.g. flange portion 216a, that is encased by portion 210a of pipe fitting 208. In examples, as also shown in FIG. 2C, a second insulating ring 222b may be provided below the first end of connecting structure 216, e.g. flange portion 216a, that is encased by portion 210a of pipe fitting 208.

In examples, additional insulating material 224 configured to insulate and prevent the flow of an electric current between two electrically conductive surfaces. In examples, the insulating material 224 may include a gasket, packing material, or both. In examples, the insulating material 224 may include a phyllosilicate mineral, for example, vermiculite. Other materials may also be used.

In examples, a first tube section 202a may be welded to a top surface 226 of a portion 210b of pipe fitting 208. In examples, a second tube section 202b may be welded to a second end of connecting structure 216. In examples, the second end of connecting structure 216 may be opposite the first end of connecting structure 216 that is encased by a portion of pipe fitting 208. For example, as illustrated in FIG. 2C, a second tube section 202b may be welded to an end 228 of stub portion 216b of connecting structure 216 whose flange portion 216a is encased in portion 210a of pipe fitting 208.

In examples, the connections of a tube section to a pipe fitting 208 may be configured to account for differential expansion with the pipe section when heated. In examples (not shown), this may be done by attaching stops, clamps, or other like fasteners to each connected tube section on either side of the pipe fitting 208 to hold the tube sections in a fixed position around the pipe fitting. The stops, clamps or other fasteners may be fixed to one or more supports 134 and/or 204. In examples, the stops, clamps or other fasteners may be electrically non-conductive. In examples, the stops, clamps or other fasteners may exhibit sufficient structural strength to direct the pipe expansion in another location and direction away from the pipe fitting 208 as in an expansion loop.

In examples, each tube section 202 may be electrically isolated from other tube sections. In examples, tube sections 202 may be electrically interconnected serially or in parallel. In examples, the system may be configured to provide current to each tube section 202 independently. As discussed earlier, current to a tube section may be provided by one or more electrical connections 206. In examples, the power source connected to a first tube section may be the same or different from the power source connected to a second tube section. In examples, the power source connected to a first tube section is separate and apart from the power source connected to a second tube section. In examples, one or more controllers may be configured to control the application of current supply to a tube section. In examples, at least a first tube section may be connected to a first power or electrical current supply. In examples, at least a second tube section may be connected to a second power or current supply. In examples, the first current supply and second current supply may be the same or different current supply. In examples, the first and second current supplies may be connected to each other.

In examples, the steam cracking furnace 114 through which the one or more cracking tubes 112 extend may require sufficient heat to carry out the reaction inside the cracking tubes 112 and/or to provide sufficient heat to the preheating section 116 for heating or pre-heating of one or more feed streams via one or more preheating tubes 110 as previously described. In examples, a correlation between the amount of heat energy desired and the amount of current necessary to generate such heat may be drawn. In examples, the correlation may be based on the dimensions and metallurgy of one or more preheating tubes 110, cracking tubes 112, or both. In examples, the correlation may be stored in memory such as in a look-up table. In examples, the control system may be designed to access the information to control the operation of the system. In examples, in determining the amount of current to drive through the one or more preheating tubes, cracking tubes, or both, the system may take into consideration any additional heating source optionally available in the steam cracking furnace 114 such as one or more burners or other heating elements. In examples, one or more sensors may be implemented to monitor the temperature of a preheating tube or of a cracking tube. In examples, the amount of current driven through a preheating tube or a cracking tube may be adjusted based on the sensor information. In examples, the one or more sensors may include a thermal sensor such as a thermometer or a thermocouple.

In examples, the overall power provided to a furnace may depend on the desired total heat generation, the presence of optional additional heating elements such as burners and/or heaters, the size of the furnace, or any combination thereof. In examples, the total power provided to a furnace may be about 10 MW or greater. For example, the total power may be up to 100 MW or greater. For example, the total power may be 10 MW, 20 MW, 50 MW, 100 MW, 105 MW, 110 MW, 115 MW, 120 MW, 125 MW, 130 WM, 135 MW, 140 MW, 145 MW, 150 MW, 155 MW, 160 MW, 165 MW, 170 MW, 175 WM, 180 MW, 185 MW, 190 MW, 195 MW, 200 MW or within a range defined by any two of the exemplified values. In examples, the total power may be higher than 200 MW.

In examples, the total current determined as required for a given cracking heat output may be applied to a single cracking tube 112 if doing so does not damage the cracking tube 112 or it may be divided among two or more cracking tubes 112. In examples, the total current determined as required for a given heat output may be divided among two or more cracking tubes 112. In examples, when separating the current among multiple cracking tubes 112, the amount of current driven through each cracking tube 112 may be independently determined. For example, the amount of current driven through each cracking tube 112 may be dependent on the specific cracking tube dimensions, metallurgy, amount of heat desired from that cracking tube, or any combination thereof.

In examples, the total current determined as required for a preheating may be applied at least in part to one or more preheating tubes 110. In examples, when separating the current among multiple preheating tubes 110, the amount of current driven through each preheating tube 110 may be independently determined. For example, the amount of current driven through each preheating tube 110 may be dependent on the specific preheating tube dimensions, metallurgy, amount of heat desired from that preheating tube, or any combination thereof.

In examples, the total current determined as required for a given total heat output in the steam cracking furnace 114 may be divided among one or more preheating tubes 110 and one or more cracking tubes 112. In examples, more current is provided to one or more cracking tubes 112 than to one or more preheating tubes 110. In examples, more current is provided to one or more preheating tubes 110 than to one or more cracking tubes 112. In examples, the same amount of current is provided to one or more preheating tubes 110 and to one or more cracking tubes 112.

In examples, the current may be evenly distributed among two or more cracking tubes 112, two or more preheating tubes 110, or combination thereof. In examples, even distribution may be possible where the two or more cracking tubes and/or preheating tubes have the same dimensions and metallurgy. Other instances in which even distribution of current may be possible may also be present without requiring the two or more cracking tubes and/or preheating tubes to have the same dimensions and/or metallurgy.

For examples, to generate a desired reaction heat, the total current through the one or more cracking tubes 112 may be defined by the capabilities of available controller/rectifiers and electrical connections to the one or more cracking tubes 112. In examples, the total current for cracking tubes 112 may be up to 110,000 A per rectifier. In an example, the total current through the one or more cracking tubes 112 may be about 15,200 A.

In examples, the total reaction heat energy may be provided by multiple cracking tubes 112. In examples, where multiple cracking tubes 112 are used, the total heat required for the pyrolysis section may be provided by the combined heating of the cracking tubes 112. For example, a pyrolysis section 118 may include four cracking tubes 112. In examples, where generation of the total reaction heat desired may require about 15,200 A, each cracking tube may be provided with about 3,800 A.

In examples, it may be desired to provide sufficient heat to preheat one or more feed streams in the preheating section 116. In examples, additional current may be necessary to generate the additional heat desired via electrical resistance heating at one or more of the preheating tubes 110. In examples, the additional current to the one or more preheating tubes 110 may also be defined by the capabilities of available controller/rectifiers and electrical connections to the one or more preheating tubes 110. In examples, the total current for preheating tubes 110 may be up to 110,000 A per rectifier.

For example, an additional current ranging from about 7,381 A to about 15,706 A may be necessary to generate additional heat via preheating tubes 110 to pre-heat one or more feed streams, such as hydrocarbon feed 126, vapor stream 128, mixed feed stream 132, and/or to heat other streams such as water or vapor to produce vapor or superheated vapor. In examples, different currents may be used to preheat different streams. For example, 7,381 A may be used to preheat a hydrocarbon feed 126, while 7,686 A may be used to preheat steam feed 128. In examples, 14,310 A may be used to preheat mixed feed stream 132.

These are just examples and other current values may be used. In examples, the additional current may also be applied to the one or more preheating tubes 110 to generate the additional desired heat. In examples, the current may be divided evenly among the one or more preheating tubes 110. In examples, the current supplied to a first preheating tube 110 may be different from the current supplied to at least a second preheating tube 110.

In examples, the heat generated by driving a current through one or more preheating tubes, cracking tubes, or both, in the steam cracking furnace 114 may be supplemented by heat generated by other means. For example, the steam cracking furnace 114 may include one or more burners and/or additional heating elements such as electric heaters, jackets, or the like. In examples, the total desired heat energy to operate the steam cracking furnace 114 may be provided by a combination of heat generated by the one or more preheating tubes 110 and/or cracking tubes 112 via electrical resistance heating and heat generated by one or more other means. In examples, all of the heat energy desired for the furnace may be generated via electrical resistance heating by driving a current through one or more cracking tubes and/or preheating tubes.

In examples, the system may be configured to ensure that it may be compatible with the capabilities of commercial power supplies. Commercial power supplies may be limited to kilo-ampere ranges. As such, to ensure that sufficient heat energy and thus sufficient current is used to generate the desired heat energy, the system may be configured to include one or more preheating tube sections and/or cracking tube sections.

In examples, a variable tube current may be provided to one or more tube sections 202. In examples, the variable tube current may be provided independently to each tube section. In examples, the same variable tube current may be provided to at least two tube sections 202. In examples, the variable tube current provided to a first tube section may be from a first power source. In examples, the variable tube current provided to a second tube section may be from a second power source. In examples, the first power source and the second power source may be separate and independent power sources, connected power sources, or the same power source.

In examples, the variable tube current may be a direct current (DC) or an alternating current (AC). In examples, the variable tube current may be a direct current. In examples, use of direct current may help reduce or negate any inductance effects of the cracking tubes and/or tube sections. In examples, use of direct current may reduce or eliminate skin effect (AC current typically travels closer to the surface of the conductor as frequency increases). In examples, use of direct current may take advantage of existing high-current DC transformer-rectifier technology, for example, like the technology used in electrolysis and/or electrowinning.

In examples, the electrical current supply to the one or more resistance heating tubes such as preheating tubes and/or cracking tubes may be provided by any suitable electrical equipment. In examples, a current supply system 138 may be configured to supply electrical current to the one or more resistance heating tubes. In examples, an electrical current supply system 138 may include one or more transformers, rectifiers or other suitable equipment as generally available.

For example, the current supply system 138 may be implemented as current supply system 300 shown in FIG. 3. In examples, current supply system 300 may include one or more silicon controlled electrical rectifiers (SCRs) 302 or thyristors fed from a dedicated input transformer 304. Other semiconductor technologies may also be used, such as, for example, insulated-gate bipolar transistors (IGBTs) and the like.

In examples, the current supply to each rectifier 302 may be any power source. In examples, the power source may be a power grid. In examples, the power source may be a power storage source such as a battery or fuel cell. In examples, the power source may be regenerative power source such as a solar power generator, hydroelectric turbine, geothermal turbine, or any like sources.

In examples, the power source may provide the wattage required to generate the desired heat. In examples, a power source may provide 100 MW as may be necessary for all rectifiers. In examples, the supply voltage may be about 34.5 kV (33 kV in IEC countries) or higher. In examples, two or more power sources may be used together to generate the desired power. In examples, where two or more power sources are used, one power source may be the same or different from another power source. For example, each power supply source may independently be selected from a power grid, a power storage source, and a regenerative power source and combined with another independently selected power source.

In examples, the current may travel from a rectifier 302 to a tube section 306, represented as a resistance in circuit diagram shown in FIG. 3, via a bus bar 308. As illustrated in FIG. 3, in examples, the same or separate rectifiers 302 and bus bars 308 may be used to feed current to different resistance heating tubes or tube sections. In examples, a bus bar 308 may include an electrically conductive material such as a metal or metal alloy. In examples, a bus bar 308 may include copper or copper wire. In examples, a bus bar 308 may include a wire with cross-section that is suited for the conduction of the desired current. In examples, a bus bar 308 may include a wire with cross-section of about 6 mm by about 200 mm. In examples, a bus bar 308 may be a bare bus bar. In examples, a bare bus bar refers to a bus bar that is not covered by insulating material at one or more locations. In examples, a bare bus bar may be supported by one or more insulator supports. In examples, an insulator support may extend to one or more rectifiers 302. In examples, a bus bar 308 may extent from outside a steam cracking furnace to one or more impedance heat tubes and/or tube sections located inside the steam cracking furnace.

In examples, the current supplied to a tube section may be controlled by one or more controllers 310. For example, the current driven through a tube section may be controlled by one or more proportional-integral-derivative (PID) controllers. In examples, control of the current driven through a tube section may provide control of heating at that tube section. In examples, each the current driven through a tube section may be controlled by one or more PID controllers. In examples, the output of a PID controller may be used as the electrical current setpoint for the rectifier set driving the tube section. In examples, one or more temperature sensors (not shown) suitable for the application may employed to monitor the temperature of a tube section. In examples, a temperature sensor may include a thermometer, a thermocouple or like device. In examples, a rectifier may be configured to respond and control and/or adjust a current flow based on the feedback from the PID controller and/or temperature sensors. In examples, the rectifier response may be either delayed or near instantaneous.

In examples, one or more resistance heating tubes, i.e. one or more preheating tubes and/or one or more cracking tubes, may be configured to minimize or cancel magnetic fields that may generate with the application of a current. Opposite currents on adjacent conductors may create a repelling force between the two, and currents in the same direction may create an attraction force. Configuring one or more resistance heating tubes to minimize or cancel magnetic fields that may generate with the application of a current. In examples, one or more supports may be used to aid in withstanding the forces that may be posed by the application of a current flowing through the magnetic field of another nearby current.

In examples, the one or more preheating tubes and/or cracking tubes may be configured such that current flowing through adjacent tubes travels in opposite directions. In examples, the one or more electrical connections to the one or more preheating tubes and/or cracking tubes may be configured such that current flowing through adjacent tubes travels in opposite directions. In examples, resistance heating tubes may be configured, positioned, and/or routed such that the electric current flowing in one resistance heating tube, tube section, or group of resistance heating tubes and/or tube sections returns on an adjacent resistance heating tube, tube section, or group of cracking tubes or tube sections. In this manner, it may be possible to minimize or cancel-out the magnetic fields away from the resistance heating tubes and/or tube sections.

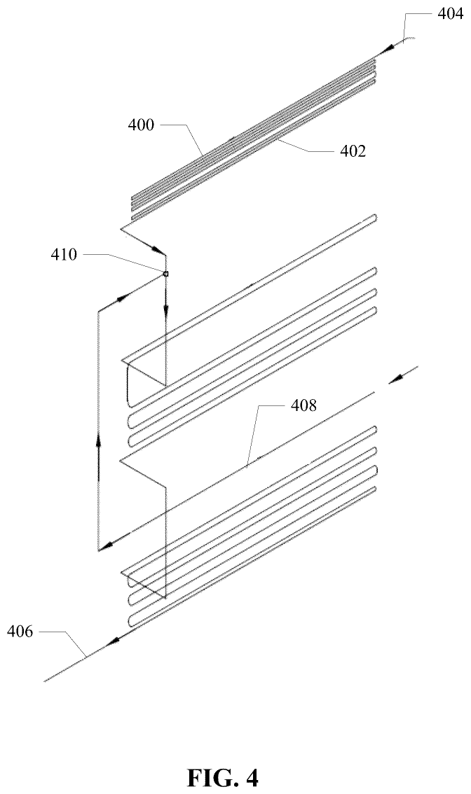

For example, as shown in FIG. 4, in the case of the preheating a feed, steam, and/or mixed feed stream, a continuous preheating tube 400 may be lapped back and forth. In examples, a preheating tube 400 may be configured as one or more coils. As illustrated, preheating tube 400 may include one or more coil segments 402. In examples, a fluid may be fed to preheating tube 400 at least at a first end 404. In examples, a fluid exit 406 may be provided at an opposite end of preheating tube 400. In this manner, the current flowing through each coil segment 402 may be opposite the next coil segment thus minimizing and/or canceling-out the magnetic fields. In examples, one or more additional preheating tubes 408 may be present. In examples, a first preheating tube 400 may be optionally fluidly connected to a second preheating tube 408 as shown in FIG. 4. In examples, one or more connection points 410 such as a mixing manifold or other like structure may be used to fluidly connect one preheating tube 400 to a second preheating tube 408.

In examples, as previously discussed with reference to FIGS. 1 to 2A-2B, one or more supports 134 and 204 may be used to compensate for the forces posed by a current of a tube section flowing through the magnetic field created by another current flowing through an adjacent tube section when the arrangement is adopted to cancel out of a magnetic field generated by the application of a current to a preheating tube and/or tube sections thereof.

In examples, cracking tubes may be required to generate more heat than preheating tubes. In examples, to generate more heat, it may be desirable to flow more current through the cracking tubes than through the preheating tubes. Flowing a higher current may lead to enhanced forces the cracking tubes must withstand due to currents flowing through adjacent tube sections flow through the generated magnetic fields at the adjacent tube sections. In examples, the maximum calculated lateral force on a cracking tube may be as much as 160 lbf. In examples, arrangement of cracking tubes and/or employment of a support configured to account for the lateral force expected to be exerted on the cracking tubes when attempting to cancel out the magnetic fields and/or forces that may generate with the application of a current may be employed. In examples, a support may be configured to provide sufficient strength to withstand the lateral force expected to be exerted on the cracking tubes when attempting to cancel out the magnetic fields and/or forces that may generate with the application of a current. In examples, the support may be configured to provide sufficient strength to minimize or prevent substantial bending of one or more cracking tubes. In examples, the support design may be configured to prevent the one or more cracking tubes and/or coils to bend beyond an operational tolerance.

FIGS. 5A and 5B illustrate an example of an arrangement of multiple cracking tubes in a pyrolysis section of steam cracking furnace to cancel out magnetic fields generated by the application of a current. Other arrangements may also be implemented, what is shown in FIGS. 5A and 5B is only one example.

FIGS. 5A and 5B illustrate a front view and back view of an example arrangement of cracking tubes in a pyrolysis section 500 of a steam cracking furnace. In examples, the cracking tubes may be arranged in tube sets 502 (e.g. 502a, 502b, 502c, 502d, etc. . . . ) For example, illustrated are four tube sets 502a, 502b, 502c, and 502d each having eight cracking tubes 504. In examples, one or more cracking tubes 504 may be fixed at least at one end to enable an electrical connection to connectors 508 (e.g. 508a, 508b, 508c, 508d, 508e). In examples, one or more insulating connections 516 (e.g. 516a, 516b, 516c, 516d, 516e, 516f, 516g, and 516h) may be provided to isolate the electrical connections to the one or more cracking tubes 504 from other components in the steam cracking furnace. In examples, the insulating connections 516 may include an electrically insulating pipe fitting 208 as previously described. In examples, an electrical connector may include any suitable electrical connector to supply a current to the one or more cracking tubes. In examples, one or more first end supports 506 (e.g. 506a, 506b, 506c, 506d, 506e, 506f, 506g, 506h, etc. . . . ) may be used. In examples, a first end support 506 may hold at least a first end 510 of one or more cracking tubes 504. In examples, a first end support 506 may include a stationary support configured to hold the first end 510 of one or more cracking tubes 504 in a fixed location to enable the installation of an electrical connection 508. In examples, first end support 506 may be fixed to a stationary structure 518 such as a wall or bracket or frame of the cracking furnace. For example, as shown in FIG. 5A, a first end support 506 may include a tetra end structure. As used herein a tetra end structure refers to a stationary support 506 that is configured to hold at least a first end 510 of four cracking tube 504. In examples, one or more first end supports 506 may be used to hold multiple first ends 510 of multiple cracking tubes 504. In examples, an electrical connection 508 may be made to the stationary support 506 and the current may then be transferred to the one or more support cracking tubes via the stationary support 506. In examples, an electrical connection 508 may be provided to each first end support 506.

In examples, a first end support 506 may function as a duct. In examples, first end support 506 may include a hollow portion to allow fluid flow. In examples, first end support 506 may be in fluid connection with one or more cracking tubes 504. In examples, first end support 506 may function as an influent inlet or as an effluent outlet of the one or more cracking tubes. In examples, first end support 506 may function as the effluent outlet of the one or more cracking tubes.

In examples, as shown in FIG. 5B, the second ends 512 of the one or more cracking tubes 504 may be connected to one or more manifolds 514 (e.g., 514a, 514b, 514c, 514d, etc. . . . ). In examples, a manifold 514 may be stationary to enable a connection between one or more feeds and the one or more cracking tubes 504. In examples, the second end 512 of a cracking tube 504 may include an infeed end. In examples, a manifold 514 may be configured to infeed one or more gasses to the cracking tubes.

In examples, the manifold 514 may be configured to fluidly connect to one or more second ends 512 of one or more cracking tubes 504. In examples, the manifold 514 may be configured to connect and/or support at least the second ends 512 of at least all of the cracking tubes 504 whose first end is supported by the same first end support 506. In examples, a manifold 514a may be configured to fluidly connect to the second ends 512 of one or more cracking tubes 504 whose first end is supported by one first end support 506a and to fluidly connect to the second ends 512 of one or more cracking tubes 504 whose first end is supported by another first end support 506b.

In examples, to moderate flow of gas fluid through one or more cracking tubes 504, each second end 512 of each cracking tube 504 may include a nozzle 520. In examples, a nozzle 520 may include a critical flow nozzle. In examples, a nozzle 520 provided at each second end 512 of each cracking tube 504 may ensure that the gas fluid flow through each cracking tube 504 is the same or similar.

In examples, by connecting the second ends 512 of multiple cracking tubes 504 supported by different first end supports 506 to the same manifold 514, it may be possible to arrange the one or more cracking tubes 504 in a manner that can help minimize or cancel out a magnetic field generated with the application of a current to the one or more cracking tubes 504.

In examples, the manifold 514 may include a conductive material. In examples, the conductive nature of the manifold 514 allows for the electrical connection between second ends 512 of different cracking tubes 504. In examples, as an electric current is applied via a first electrical connection 508 at first end support 506 to a first cracking tube, the current may travel along the first cracking tube, reach the manifold 514, and transfer to the second end 512 of a second cracking tube, travel along the second cracking tube, reach the first end 510 of the second cracking tube connected to the same or different first end support 506 and thus to the same or different electrical connection 508. In examples, one or more cracking tubes 504 supported by one first end support 506a may be arranged in an alternating fashion with one or more cracking tubes 504 supported by a different first end support 506b. In this manner it may be possible to apply a current to the cracking tubes 504 in series and obtain countercurrent flow of current among adjacent cracking tubes 504. In examples, each tube set 502 may include eight cracking tubes in alternating arrangement as described. In examples, each tube set 502 may then be electrically connected in series to at least one other tube set 502. For example, tube set 502a may be electrically connected in series to tube set 502b, that may be electrically connected in series to tube set 502c, which may be electrically connected in series to tube set 502d.

In examples, the electrical connection between two tube sets 502 may be made at or proximate to first end supports 506. In examples, an electrical connection 508b may connect first end support 506b to first end support 506c. In examples, an electrical connection 508c may connect first end support 506d to first end support 506e. In examples, an electrical connection 508d may connect first end support 506f to first end support 506h. In examples, additional electrical connections 508a and 508e may be employed to connect first end support 506a and first end support 506h respectively to outside current source to complete the electrical circuit. These are just examples as other connection arrangements may also be implemented.

In examples, the one or more resistance heating tubes such as preheating tubes and/or cracking tubes may be configured to compensate and/or withstand tube growth. In examples, heating of a resistance heating tubes may cause the expansion of the resistance heating tube. In examples, a resistance heating tube may expand and/or grow as current is applied to the cracking tube thereby heating it.

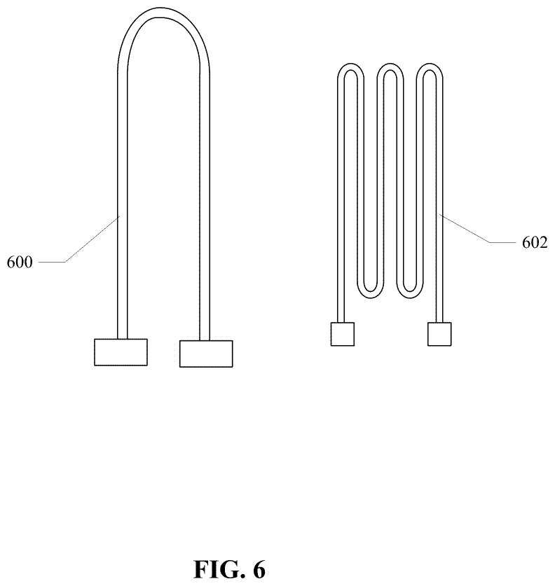

In examples, a resistance heating tube such as a preheating tube and/or a cracking tube may have any desired shape, size, and design. In examples, by generating heat directly by the tubes rather than by one or more burners may allow greater flexibility in tube design, routing, shape, and support. In examples, a resistance heating tube may have a longitudinal shape. As for example shown in FIG. 6, in examples, a resistance heating tube may have a curved and/or curvilinear shape. In examples, a resistance heating tube growth and/or expansion may be accounted for by its shape, size, design, and/or by one or more support methods. In examples, a resistance heating tube 600 may be bent into a “U” shape. In examples, a resistance heating tube 600 may be bent into a vertical “U” shape. In examples, a resistance heating tube 602 may be bent into a coil. In examples, a resistance heating tube 602 may be bent into a horizontal coil also illustrated earlier for example in FIG. 4. In examples, a resistance heating tube may be suspended from its ends. In examples, a resistance heating tube may be bent into a U-shape and suspended from its ends as for examples discussed with reference to FIGS. 5A and 5B. In examples, one or more resistance heating tubes may be designed, routed, shaped, oriented, and/or supported in a similar manner or in different manners. In examples, one or more preheating tubes may be designed, routed, shaped, and/or supported in a similar manner. In examples, one or more preheating tubes may be designed, routed, shaped, and/or supported in different manners. In examples, one or more cracking tubes may be designed, routed, shaped, and/or supported in a similar manner. In examples, one or more cracking tubes may be designed, routed, shaped, and/or supported in different manners.

In examples, the systems described herein may include one or more control systems, sensors, and other standard components that allows for the control and operation thereof.

In examples, although not shown, the systems described herein may include one or more sensors as generally employed in the art. In examples, sensors may be used to monitor the operation of the systems described. Non-limiting examples of one or more sensors may include temperature sensors, pressure sensors, flow meters, and other like sensors.

In examples, although not shown, the one or more control systems may include one or more controllers and/or other suitable computing devices may be employed to control one or more of portions of systems described herein. Controllers may include one or more processors and memory communicatively coupled with each other. In the illustrated example, a memory may be used to store logic instructions to operate and/or control and/or monitor the operation of the system as described. In examples, the controllers may include or be coupled to input/output devices such as monitors, keyboards, speakers, microphones, computer mouse and the like. In examples, the one or more controllers may also include one or more communication components such as transceivers or like structure to enable wired and/or wireless communication. In examples, this may allow for remote operation of one or more systems described herein.

In examples, memory associated with the one or more controllers and/or other suitable computing devices may be non-transitory computer-readable media. The memory may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/Flash-type memory, or any other type of memory capable of storing information. The controls systems may include any number of logical, programmatic, and physical components.

Logic instructions may include one or more software modules and/or other sufficient information for autonomous operation, safety procedures, and routine maintenance processes. Any operation of the described system may be implemented in hardware, software, or a combination thereof. In the context of software, operations represent computer-executable instructions stored on one or more computer-readable storage media that, when executed by one or more processors, perform the recited operations. Generally, computer-executable instructions include routines, programs, objects, components, data structures, and the like that perform one or more functions or implement particular abstract data types.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A steam cracking unit comprising:
a resistance heating tube; and
an electrical current supply connected to the resistance heating tube configured to apply a current to the resistance heating tube to induce electrical resistance heating.

2. The steam cracking unit of claim 1, wherein the resistance heating tube comprises a preheating tube.

3. The steam cracking unit of claim 2, further comprising a preheating section, wherein the preheating tube is located at least in part in the preheating section.

4. The steam cracking unit of claim 2, wherein the preheating tube is configured to preheat a hydrocarbon feed, a steam feed, a mixed feed stream of hydrocarbon feed and steam feed, or any combination thereof.

5. The steam cracking unit of claim 2, wherein the preheating tube is arranged such that a feed is directed to flow through the preheating tube prior to reaching a pyrolysis section.

6. The steam cracking unit of claim 1, wherein the resistance heating tube comprises a cracking tube.

7. The steam cracking unit of claim 6, further comprising a pyrolysis section, wherein the cracking tube is located at least in part in the pyrolysis section.

8. The steam cracking unit of claim 1, further comprising a rectifier to provide the electrical current supply.

9. The steam cracking unit of claim 1, further comprising a controller to adjust the electrical current supply to the resistance heating tube.

10. The steam cracking unit of claim 1, wherein the resistance heating tube comprises a curved or curvilinear shape.

11. The steam cracking unit of claim 4, wherein the resistance heating tube comprises a U-shape.

12. The steam cracking unit of claim 1, wherein the resistance heating tube comprises two or more tube sections.

13. The steam cracking unit of claim 12, wherein a first tube section is connected to a second tube section by a pipe fitting configured to electrical-insulate the first tube section from the second tube section.

14. The steam cracking unit of claim 13, wherein at least a first tube section of the two or more tube sections is connected to the electrical current supply.

15. The steam cracking unit of claim 14, wherein at least a second tube section of the two or more tube sections is connected to a second electrical current supply.

16. The steam cracking unit of claim 15, wherein the electrical current supply connected to the first tube section is independent of the second electrical current supply connected to the second tube section.

17. The steam cracking unit of claim 13 wherein the pipe fitting comprises a first portion and a second portion configured to mate.

18. The steam cracking unit of claim 1, further comprising additional one or more resistance heating tubes.

19. The steam cracking unit of claim 18, wherein the resistance heating tube and the additional one or more resistance heating tubes are configured such that current flowing through adjacent tubes travels in opposite directions.

20. A steam cracking process comprising:
feeding a hydrocarbon feed to one or more resistance heating tubes of a steam cracking furnace;
applying a current to the one or more resistance heating tubes to induce electrical resistance heating while the hydrocarbon feed flows through the one or more resistance heating tubes; and
preheating the hydrocarbon feed, cracking the hydrocarbon feed, or both while flowing through the one or more resistance heating tubes.

21. The steam cracking process of claim 20, further comprising feeding steam to the one or more resistance heating tubes to mix with the hydrocarbon feed.

22. The steam cracking process of claim 20, further comprising controlling the current applied to the one or more resistance heating tubes to adjust the electrical resistance heating.

23. The steam cracking process of claim 20, wherein applying a current to the one or more resistance heating tubes comprises applying a current to a first tube section of one resistance heating tube of the one or more resistance heating tubes independently of a second tube section of the one resistance heating tube.

24. The steam cracking process of claim 20, wherein the electrical resistance heating is the only heat generated in the steam cracking furnace.
